(19) United States
(12) Patent Application Publication
(10) Pub. No.: US 2015/0278874 A1
(43) Pub. Date: Oct. 1, 2015

(54) DYNAMIC DIGITAL CONTENT SYNCHRONIZATION AND ROUTING SYSTEM

(71) Applicant: iZipline LLC, Sarasota, FL (US)

(72) Inventors: Michelle A. Moulin, Sarasota, FL (US); Troy Pittman, Sarasota, FL (US); Keoki Trask, Sarasota, FL (US)

(21) Appl. No.: 14/667,801

(22) Filed: Mar. 25, 2015

Related U.S. Application Data
(60) Provisional application No. 61/970,184, filed on Mar. 25, 2014.

(51) Int. Cl. G06Q 30/02; H04W 4/00; H04W 56/00; G06Q 20/32

(52) U.S. Cl. CPC G06Q 30/0267; G06Q 20/32; H04W 4/008; G06Q 30/0281; H04W 56/0015

(57) ABSTRACT

A digital electronic multimedia synchronizing and routing system. The system has a dynamic digital presentation system (DPS), a content controller and a plurality of digital primary presentation (DPP) contents. Also, the DPS and the content controller display each of the plurality of DPP contents on the DPS per a pre-defined time schedule. The system also includes an interactive content platform with a plurality of customizable digital secondary interactive (CDSI) contents or presentations. The interactive content platform is in synchronization with the pre-defined time schedule for the display of each of the plurality of DPP contents, and per a contactless data-exchange protocol engagement with a personal electronic device (PED), the interactive content platform provides synchronized CDSI content to the PED.

### CROSS-REFERENCE TO RELATED APPLICATION

The instant application claims priority to U.S. Provisional Patent Application No. 61/970,184 filed on Mar. 25, 2014, which is incorporated in its entirety herein by reference.

### FIELD OF THE INVENTION

The present application is directed to a dynamic digital content system, and in particular, to a dynamic digital content system that synchronizes a user's personal electronic device with primary content presentations.

### BACKGROUND OF THE INVENTION

The use of dynamic digital data, images, content, etc., for providing information to individuals is known. For example, airports, train stations, malls and the like use large digital displays to provide advertisements, news and the like to people traveling, shopping, etc. In addition, such displays typically have changing content, i.e. an image, video clip, etc., that is displayed for a given amount of time before different content is displayed for viewing. However, it is appreciated that such “dynamic content” is generally non-interactive, i.e. heretofor dynamic content systems do not provide or allow for the possibility of providing additional information on current displayed content in real time. Therefore, a system that provides additional related dynamic content, in real time, for a given displayed content that an individual is viewing would be desirable.

### SUMMARY OF THE INVENTION

A digital electronic multimedia synchronizing and routing system is provided. The system has a dynamic digital presentation system (DPS), a content controller and a plurality of digital primary presentation (DPP) contents. Also, the DPS and the content controller display each of the plurality of DPP contents on the DPS per a pre-defined time schedule.

The system also includes an interactive content platform with a routing selector and a plurality of customizable digital secondary interactive (CDSI) contents or presentations. The interactive content platform with the routing selector is in synchronization with the pre-defined time schedule for the display of each of the plurality of DPP contents. Also, each of the plurality of CDSI contents has content related to a given DPP content.

A contactless data-exchange object, e.g. an NFC tag, programmed to direct a portable electronic device (PED) with a contactless data-exchange reading system, e.g. an NFC tag reader, to the interactive content platform can also be included. In the event that the PED is directed to the interactive content platform, e.g. via a URL call, the interactive content platform with the routing selector provides at least one of the plurality of CDSI contents to the PED to be displayed on the screen and be viewable by a user. In addition, the CDSI content(s) provided and displayed on the PED screen is unique to a time when the NFC tag reader of the PED reads the NFC tag such that the provided CDSI content is in synchronization with a DPP content that was or is being viewed by a user.

In some instances, the synchronization of the content controller with the interactive content platform is provided by a broadcast synchronization signal therebetween. For example and for illustrative purposes only, the DPS can provide the broadcast synchronization signal to the interactive content platform, or in the alternative, the interactive content platform can provide the broadcast synchronization signal to the content controller. In another alternative, an operator, administrator or user of the digital electronic multimedia synchronizing and routing system can select between whether the DPS provides the broadcast synchronization signal to the interactive content platform and/or the interactive content platform provides the broadcast synchronization signal to the content controller.

The digital electronic multimedia synchronizing and routing system can further include an event-trigger evaluation system that can increment or decrement an event-trigger variable as a function of an event-trigger communication received by the interactive content platform. In addition, the event-trigger evaluation system can determine if an event-trigger variable has reached or exceeded a predetermined value. In the event that the event-trigger variable has reached or exceeded the predetermined value, the interactive content platform can provide an event-triggered CDSI content specifically related to an associated event-trigger to the PED.

### BRIEF DESCRIPTION OF THE DRAWINGS

FIG. 1 is a schematic illustration of a multimedia synchronizing and routing system according to an embodiment disclosed herein;

FIG. 2 is a schematic illustration of a multimedia synchronizing and routing system according to another embodiment disclosed herein;

FIG. 3 is schematic illustration of a multimedia synchronizing and routing system according to another embodiment disclosed herein;

FIG. 4 is a schematic illustration of a multimedia synchronizing and routing system according to another embodiment disclosed herein;

FIG. 5 is a schematic illustration of a multimedia synchronizing and routing system according to another embodiment disclosed herein;

FIG. 6 is a schematic illustration of a multimedia synchronizing and routing system according to another embodiment disclosed herein;

FIG. 7 is a schematic illustration of a portable electronic device (PED); and

FIG. 8 is a schematic illustration of a computer with an interactive content platform thereon.

### DETAILED DESCRIPTION OF THE INVENTION

A multimedia synchronizing and routing system is provided. In some instances, the system mirrors the sequence and/or timing of content (“Presentation Content”) delivered via a dynamic digital presentation system (“DPS”). In addition, the system can provide editable and assignable interactive, digital content (“Interactive Content”) related to the Presentation Content.

In one embodiment, the system utilizes a broadcast synchronization signal for sequence and/or timing correlation in order to route incoming commands (including but not limited to uniform resource locator requests or “URLs”) that are initiated by a portable electronic device (PED) contactless data exchange protocol engagement. In many real-world DPS deployment environments, the availability of a direct, one-to-one connection may not be desirable for the content controller. In such scenarios, the broadcast synchronization signal can emanate from one or multiple, third-party sources that are themselves synchronized via a common schedule. The broadcast synchronization signals, working independently or collaboratively, act as a master clock to the otherwise independent hardware in order to accomplish the intended synchronization between the delivery of the Presentation Content and the Interactive Content.

In addition, the system can also store and maintain the Presentation Content at a remote database management facility and/or deliver the Interactive Content to the PED via a wireless communication network. It should be noted that it is contemplated that the database management facility may be eliminated from the system such that Presentation Content is substantially or entirely sited on a device, median or other modality which is also the point of engagement for the data exchange protocol.

The system is outlined as synchronizing DPS and PED content, however, it is appreciated that interaction of other engagement “events” and “conditions” might affect the delivery of scheduled or even “permitted” content where “permitted” implies an intended audience only. For example, in some instances one or more regulation and safety industries, such as but not limited to the fulfillment and distribution of pharmaceuticals, cannabis or MSDS regulation service providers, can limit intended events and/or intended event sequences to “trigger” the issuance of desired interactive content. In other instances, and upon a package or parcel's contactless engagement, PED-delivered content is made viewable only if specific DPS content such as safety handling or documentation procedures have been viewed and interacted with. The reverse is also true, i.e. contactless engagement with a physical device, package or parcel sets conditions that allow the recipient to receive content when interacting with a DPS's contactless engagement terminal. In any event, user interaction data with or without additional internal or external data can be tracked and stored, and thereby afford displaying one or more events that can be arranged in desired categories and/or classifications (e.g. chronological order). Such arrangement can further provide patterns and/or similarities, such as trace of movement around each of the system components, in order to build a profile of the intended sequence of events and its participants, and/or the outcome of the events and its participants.

For example, in some instances the remote database management facility (also referred to as an “interactive content platform”) can take note or track where and when users interact with it, and thus allow one to look back at the Platform logs and “draw” a linear timeline of events and locations with the intent of identifying potential bypassing of intended user interaction flow. This can be equivalent to “Track and Trace” used in Securities, Quality Assurance, etc. It is appreciated that a certain amount of Track and Trace in software solutions is required by many government institutions such as the Veterans Administration (VA). As such, the interactive content platform can and will be able actively complying with known and yet to be developed industry regulations.

Whereas synchronization is assumed to occur between two established points in time or space, the dynamic nature of the digital signage environment in which the system may be deployed is one of expanding technologies, capabilities and necessities required to reach, observe and deliver meaningful content to the modern retail consumer. As such, the inventive system disclosed herein is adaptable to multiple controllable trigger-events. The inventive system is also adaptable to independent, and potentially unpredictable dynamic conditions which may work together or independently to affect or supersede routing of presentation content that would otherwise occur should a pre-determined trigger-event have been initiated or a pre-determined condition been met. Event triggers may include but are not limited to a networked sensor, a manually-controlled switch or other value-changing device that communicates with the system via a command or data stream including but not limited to a URL.

The system's capabilities are designed to recognize and accommodate one or more conditional states or conditional events which include but are not limited to recognition of user language and engagement via a preferred language setting on a consumer's PED, local weather patterns at a point of consumer engagement, or other pre-designated conditions or range of condition states that match a pre-determined conditional trigger-event threshold.

In some instances, a retail environment with a host DPS provides the synergistic benefit of the provided synchronization technology with an Event Trigger and Conditional Routing. In such an environment, a digitally networked consumer entry counter submits to the system the number of consumers physically entering the retail environment, doing so via a command or data stream including but not limited to a URL call for each entry. As each submission is received and totaled by the system, an event-trigger variable is evaluated to determine if a preset threshold has been satisfied and thereby triggering the delivery/synchronization of desired content with consumers' PED.

Whereas Event Triggers have been presented as occurring externally, i.e. beyond the system, and whereas Conditional Routing has been presented as occurring within the system, i.e. effecting the scheduled PED content received in the real-world, the system may also employ communication to external systems as determined by preset conditions within the system having been satisfied or when acting as a repeater or translator of communication received by external devices. For example and for illustrative purposes only, the system may send a notice of the 10^{th} (tenth) consumer entry into a retail environment each time the 10^{th} (tenth) entry condition is met. In the alternative, the system may send a single notice for every consumer entry as each entry occurs, and/or the system may provide another form of interpreted data derived from sensor data and/or data received from an additional source as to provide a multiple-input and/or alternative perspective on the consumer's environment at the point of engagement.

The system may also be directed to communicate with external devices when a condition is met without having been “triggered” by an external device itself. For example, the system may be employed to communicate to a particular user based upon conditions met within the system and/or in the consumer's PED browser settings, thereby providing special insight regarding the engaged consumer as well as targeting specialists that are assigned to such a demographic. Stated differently, the system can be programmed to communicate with external, third-party devices when one or more conditions are met, even if not triggered by an external device. For example, the system can communicate to a third party PED based upon conditions met within the system and/or in an originating party's PED (e.g. User A) browser settings, and thereby provide insight, information, etc., related to the originating party as well as target the third party. This could illustratively include User A being at a retail location and having a PED browser set to a foreign language, e.g. Spanish. The Spanish setting on the PED browser is a condition met in the system and/or in User A's PED browser setting. The inventive system can then communicate with User A's PED in Spanish, as well as communicate or alert a sales associate in the retail location who speaks Spanish (User B). The sales associate can then approach or interact with User A and thereby increase the likelihood of assisting User A in their shopping experience.

The system provides contactless synchronized engagement applications for a consumer or other person with a need, desire or interest in relevant (synchronized) information experienced through digital content delivery. The digital content delivery can include visual, audio and/or other sensory presentations via a contactless data exchange protocol-enabled PED. For example and for illustrative purposes only, such contactless data exchange protocol-enabled PEDs include, but are not limited to, computer tablets, smartphones, smartwatches and other wearable computers and portable electronic communication devices.

An engagement point can also be part of the system, the engagement including but not limited to an electronically encoded/programmed Near Field Communication or “NFC” tag, as well as other means, whether contactless, tactile, biometrical or otherwise. The engagement point affords for issuance of a call to action or command for delivery of Interactive Content which initiates the programmatic steps facilitated by the system architecture to synchronize the primary Presentation Content with its assigned secondary Interactive Content. In this manner, the system enables instant, synchronized, dynamic digital content delivery by and between dynamic digital presentations, displays and/or portals and PEDs.

Through the use of a PED in conjunction with a contactless data exchange engagement point technology (engagement point), the system receives a request for delivery of Interactive Content and in turn, issues a command that instantly re-routes the PED to Interactive Content that correlates specifically with one or a plurality of Presentation Content displayed via a Presentation Content digital or non-digital display system. Signage that invites or offers a viewer to engage with the engagement point (such as an adjacent NFC tag or QR Code) may otherwise be affixed to or located near a physical digital presentation system as well as static physical signage.

Digital Presentation Content is created by a content-controller (“Content Controller”) and may be maintained on a local media player and/or at a remote site in a manor determined by the Content Controller. The Content Controller can also create and maintain Interactive Content at one or more discrete and/or integrated data storage and management facilities which are designed and programmed to deliver the dynamic Interactive Content. The system, while actively engaged or not engaged in content synchronization, is independently engaged by a PED operator which initiates and completes the delivery cycle of Interactive Content to a PED when a PED operator engages with the engagement point (such as “tapping” an NFC tag with their NFC-enabled smartphone or a reading a QR Code with a QR reader).

New or different Presentation Content can be created and displayed as and when the Content Controller desires. For example, a presentation schedule that is pre-set/pre-determined and thus routes incoming digital content requests to pre-assigned Interactive Content at designated times and locations can be employed. In the alternative, variant Presentation Content can be created and displayed dynamically in near real-time or instantaneous intervals at such times and places as the Content Controller determines. Similarly, a pre-determined range of Trigger-Events or Conditional Events may alone or with the aid of logic filters provide alternative routing that better suits the needs or desires of the consumer, the real-world environment at the time and/or Content Controller. Once an individual has engaged a contactless data exchange engagement point technology and receives the Interactive Content via the PED, the PED retains the digital content for subsequent displays on the PED.

The inventive system also encompasses the collection of action related data and information pertaining to time and place of engagement. For example, the system affords for the receipt of other data should a PED user choose to opt-into an inventive content delivery system that enables the system to generate consumer based analytics for brand and product sellers. Naturally the brand and product sellers could use such data for the development and marketing of products and services.

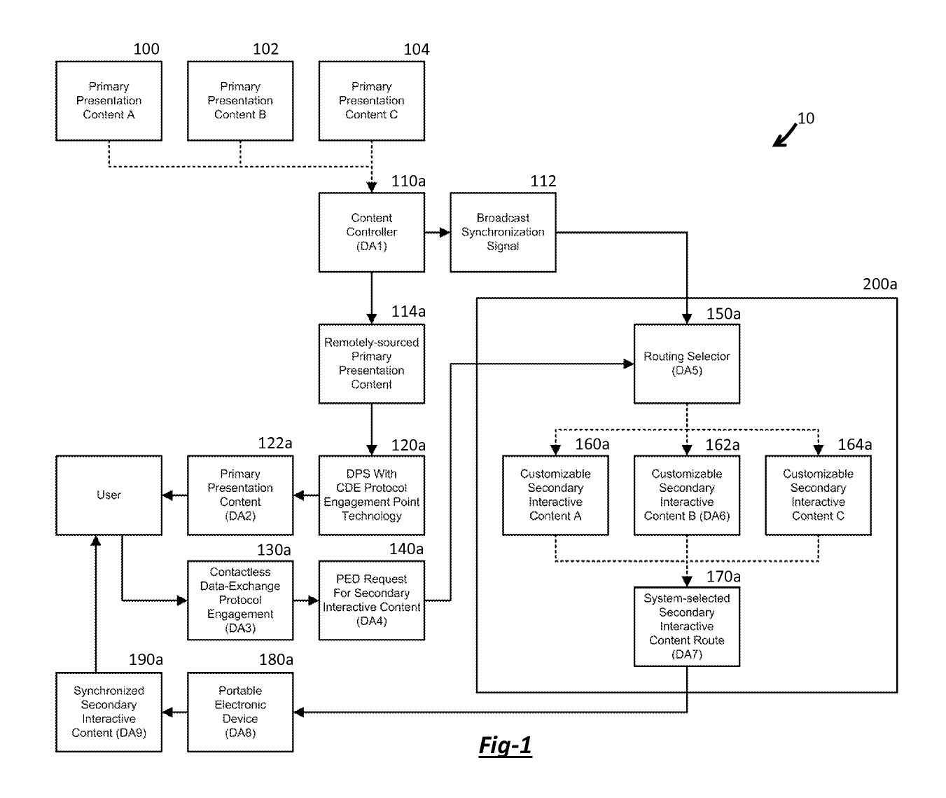

Turning now to FIG. 1, a schematic illustration of the system according to an embodiment of the present invention is shown generally at reference numeral 10. It is appreciated that FIG. 1 demonstrates a real-world application for the system despite various configurations of the environment in which it is deployed. In addition, FIG. 1 illustrates various interactions between Digital Primary Presentation (DPP) Content presentation and Customizable Digital Secondary Interactive (CDSI) Content presentation, along with synchronization of the arrival of the two presentations to a User.

Digital Primary Presentation Content is provided or is present at 100-104 and is supplied to Content Controller 110a (DA1). The Content Controller 110a selects at least one DPP Content (e.g. “Primary Presentation Content B”) that is sent to and displayed by a DPS (e.g. a Media Player). In addition, a Broadcast Synchronization Signal 112 is sent to an Interactive Content Platform 200a. Remotely-sourced Primary Presentation Content 114a can also be part of the system 10.

A DPS with Contactless Data-Exchange (CDE) Protocol Engagement Point Technology 120a can be included and the selected Primary Presentation Content is presented to the User at 122a (DA2). It is appreciated that the DPS may or may not be connected with the CDE Protocol Engagement Technology 120a. The User can actively engage with the DPS's CDE Protocol Engagement Technology using a CDE Protocol Engagement 130a (DA3) and the User's PED requests for secondary Interactive Content at 140a (DA4) are transmitted to the Interactive Content Platform 200a for continued routing. For example, the User's PED can be directed to a URL (e.g. www.iZipline.com/x) at 140a. Thereafter, a Routing Selector 150a (DA5) receives the request for secondary Interactive Content, and also receives, or has received, the broadcast synchronization signal 112.

Given the particular DPP Content 100-104 displayed to the User, and thus the particular Secondary Interactive Content request 140a provided by the Contactless Data-Exchange Protocol Engagement 130a, the Interactive Content Platform 200a determines via assignment made by Content Controller 110a which DPP Content should link to the request for CDSI Content or vice versa. Stated differently, and assuming the User has interacted with the Contactless Data-Exchange Protocol Engagement 130a while viewing DPP Content 100, the Interactive Content Platform 200a selects CDSI Content 160a. Then, a System-selected Secondary Interactive Content Route 170a extracts the CDSI Content 160a, e.g. by extracting the CDSI Content 160a URL (e.g. www.izipline.com/x/a.html).

Upon extraction of the desired Secondary Interactive Content, the User's PED 180a receives such content, e.g. by being redirected from “www.izipline.com/x” to www.izipline.com/x/a.html and the User is presented with the selected CDSI 190a (DA9) via their PED 180a that is in sync with the DPP Content displayed via the DPS 120a.

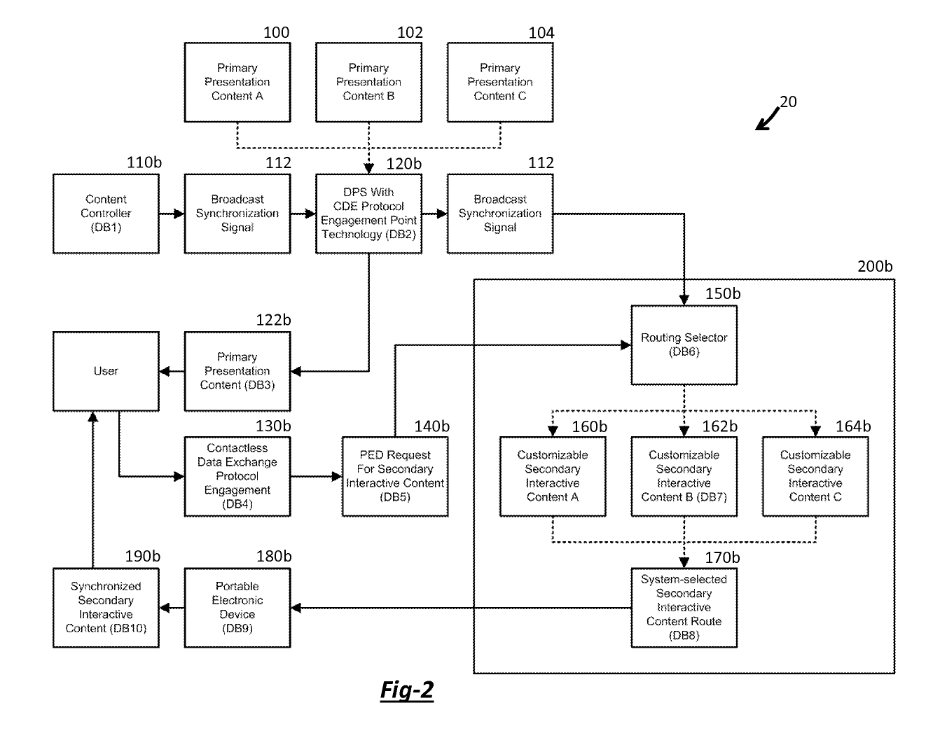

Referring now to FIG. 2, another embodiment of the present invention is shown generally at reference numeral 20. In particular, a selection of DPP Content 100-104 is made by the Content Controller 110b, e.g. DPP Content 102, and that selection is sent to a DPS with CDE Protocol Engagement Point Technology 120b, e.g. a media player (DB2). Also, a Broadcast Synchronization Signal 112 is sent from the Content Controller 110b to the DPS 120b, where it is then relayed to the Interactive Content Platform 200b and the selected DPP Content 102 is presented to the User at 122b (DB3). Then, the User actively engages with the DPS's CDE Protocol Engagement Point Technology 120b via a Contactless Data Exchange Protocol Engagement 130b (DB4) and the User's PED requests Secondary Interactive Content at 140b (DB5).

A Routing Selector 150b (DB6) receives the request for Secondary Interactive Content 140b, and also receives, or has received, the broadcast synchronization signal 112. Given the particular DPP Content 102 displayed to the User, and thus the particular Secondary Interactive Content request 140b provided by the Contactless Data-Exchange Protocol Engagement 130b, the Interactive Content Platform 200b determines via assignment made by Content Controller 110b which DPP Content 100-104 should link to the request for Secondary Interactive Content 140b. Stated differently, and assuming the User has interacted with the Contactless Data-Exchange Protocol Engagement 130b while viewing DPP Content 102, the Interactive Content Platform 200b selects CDSI 162b. Then, a System-selected Secondary Interactive Content Route 170b extracts the Secondary Interactive Content B, e.g. by extracting Secondary Interactive Content B's URL (e.g. www.izipline.com/x/b.html).

Upon extraction of the desired Secondary Interactive Content, the User's PED 180b (DB9) receives such content, e.g. by being redirected from “www.izipline.com/x” to www.izipline.com/x/b.html and the User is presented with the selected CDSI Content 190b (DB10) via their PED 180b that is in sync with the DPP Content displayed via the DPS 120b.

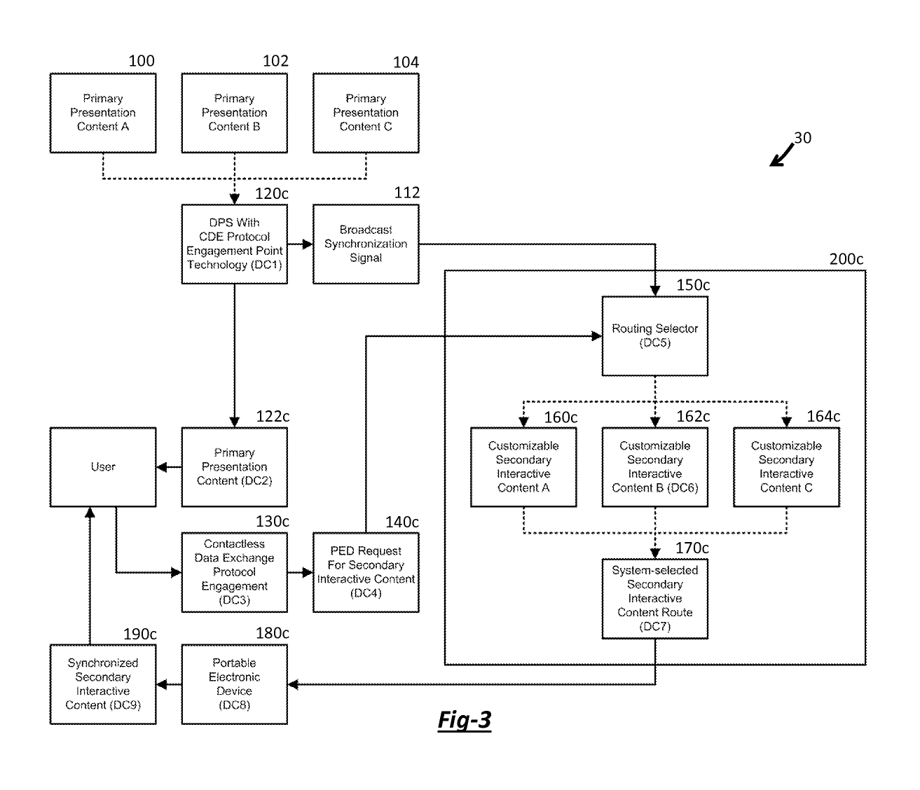

Still yet another embodiment of the present invention is shown generally at reference numeral 30 in FIG. 3. In particular, a selection of DPP 100-104, e.g. DPP Content 104, is made by a DPS with CDE Protocol Engagement Point Technology 120c, e.g. a media player (DC1). Also, a Broadcast Synchronization Signal 112 is sent from the DPS 120c to the Interactive Content Platform 200c and the selected DPP Content 104 is presented to the User at 122c (DC2). Then, the User actively engages with the DPS's CDE Protocol Engagement Point Technology 120c via a Contactless Data Exchange Protocol Engagement 130c (DC3) and the User's PED requests secondary Interactive Content at 140c (DC4).

A Routing Selector 150c (DC5) receives the request for secondary Interactive Content, and also receives, or has received, the broadcast synchronization signal 112. Given the particular DPP Content displayed to the User, and thus the particular CDSI Content request provided by the Contactless Data-Exchange Protocol Engagement 130b, the Interactive Content Platform 200c determines via assignment made by the DPS 120c which DPP Content should link to the request for CDSI Content. Stated differently, and assuming the User has interacted with the Contactless Data-Exchange Protocol Engagement 130b while viewing DPP Content 104, the Interactive Content Platform 200c selects CDSI 164c. Then, a System-selected Secondary Interactive Content Route 170c extracts the CDSI Content 164c, e.g. by extracting the CDSI 164c URL (e.g. www.izipline.com/x/c.html).

Upon extraction of the desired CDSI Content, the User's PED 180b (DB9) receives such content, e.g. by being redirected from “www.izipline.com/x” to www.izipline.com/x/c.html and the User is presented with the selected CDSI Content 190c (DC9) via their PED that is in sync with the DPP Content displayed via the DPS 120c.

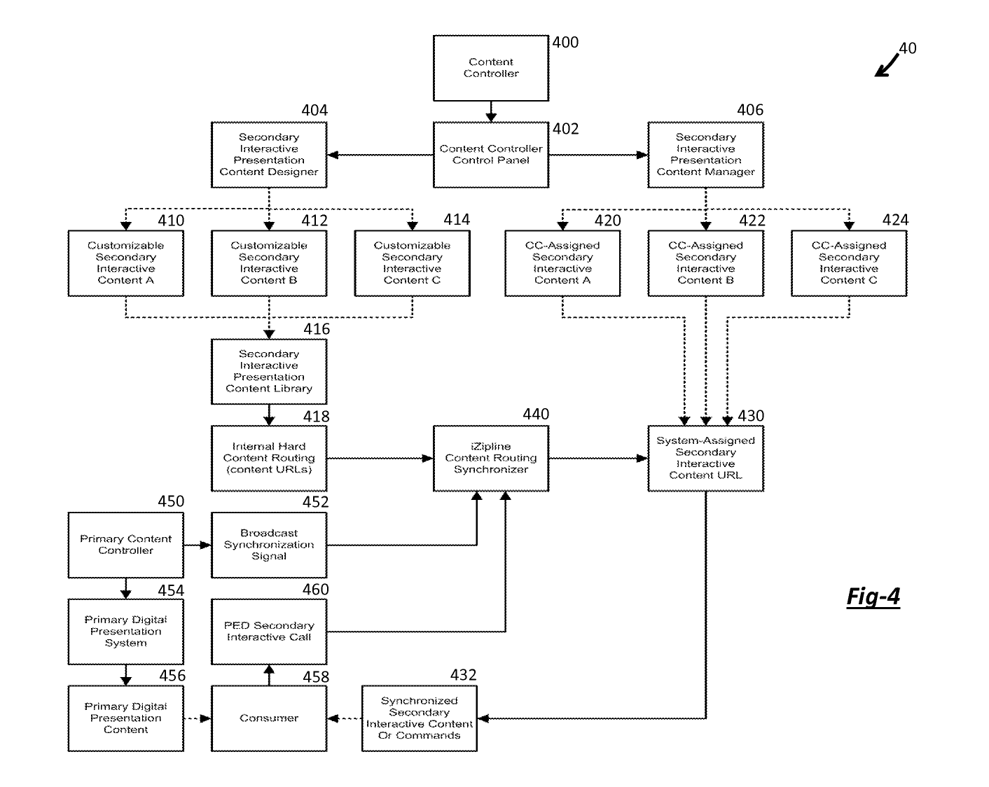

Regarding synchronization of dynamic digital content across multiple technologies, locations and times, FIG. 4 provides an illustrative diagram for an embodiment of the present invention at reference numeral 40. The system 40 can have a Content Controller 400 in communication with a Content Controller Control Panel 402. Also, the Content Controller Control Panel 402 can be in communication with a Secondary Interactive Content Designer 404 and a Secondary Interactive Content Manager 406.

The Secondary Interactive Content Designer 404 can be linked with CDSI Content 410-414 and the Secondary Interactive Content Manager 406 can be linked with Assigned CDSI Content 420-424. The Secondary Interactive Content Designer 402, and the CDSI Content 410-414, are in communication with a Secondary Interactive Content Library 416, which in turn can be in communication with Internal Hard Content Routing 418 (e.g. content URLs).

At the heart or center of the system 40 is a Content Routing Synchronizer 440, e.g. an iZipline Content Routing Synchronizer 440. The Secondary Interactive Content Library 416 and Internal Hard Content Routing 418 can be in communication with the Content Routing Synchronizer 440, which in turn is in communication with a System-Assigned CDSI Content 430, e.g. a System-Assigned CDSI Content URL.

The system 40 can include a Primary Content Controller 450. Also, the Primary Content Controller 450 can provide a Broadcast Synchronization Signal 452 which is received by the Content Routing Synchronizer 440. The Primary Content Controller 450 is also linked with a Primary Digital Presentation System 454 which provides DPP Content 456 to a Consumer 458.

The Consumer initiates or executes a PED Secondary Interactive Call 460 which is received by the Content Routing Synchronizer 440. The Content Routing Synchronizer 440 then sends information from the PED Secondary Interactive Call 460 to the System-Assigned CDSI Content 430 which can provide Synchronized CDSI Content or Commands 432 to the Consumer. In this manner, the system 40 synchronizes dynamic digital content across multiple technologies, locations, and times for the benefit of a Consumer, manufacturer, advertiser and the like. For example, multiple technologies can include but are not limited to one or more DPS's, PED's, NFC tags, externally-hosted, browser-based content and browser-based content that is hosted on the interactive content platform itself.

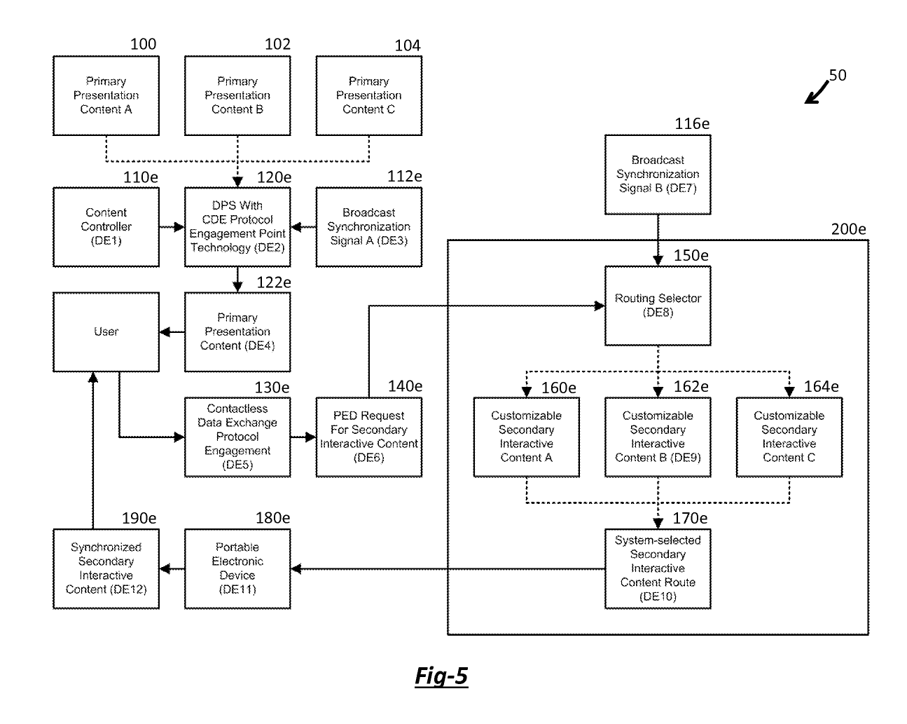

Referring now to FIG. 5, another embodiment of the present invention is shown generally at reference numeral 50. The embodiment 50 illustrates a system where broadcast synchronization emanates from one or more sources to two or more targets with one broadcast synchronization signal driving a DPS and another broadcast synchronization signal driving an interactive content platform. In particular, a selection of DPP Content 100-104 is made by the Content Controller 110e, e.g. DPP Content 102, and that selection is sent to a DPS with CDE Protocol Engagement Point Technology 120e, e.g. a media player (DE2). Also, a Broadcast Synchronization Signal A 112e is sent to and drives the DPS 120e and a Broadcast Synchronization Signal B 116e is sent to and drives Routing Selector 150e. The selected DPP Content 102 is presented to the User at 122e (DE4). Then, the User actively engages with the DPS's CDE Protocol Engagement Point Technology 120e via a Contactless Data Exchange Protocol Engagement 130e (DE5) and the User's PED requests secondary Interactive Content at 140e (DE6).

A Routing Selector 150e (DE8) receives the request for secondary Interactive Content, and also receives, or has received, the Broadcast Synchronization Signal B 116e. Given the particular DPP Content 102 displayed to the User and the Broadcast Synchronization Signal B 116e, the Interactive Content Platform 200e determines via Routing Selector 150e which CDSI Content 160e-164e is provided to the User's PED 180e via a System-selected CDSI Content Route 170e.

It is appreciated from FIG. 5, that the system affords the DPS 120e and the Interactive Content Platform 200e to be directed by broadcast synchronization signals coming from different sources. For example and for illustrative purposes only, the Broadcast Synchronization Signal A 112e can be satellite-fed time signature and the Broadcast Synchronization Signal B 116e can be a Network Time Server (NTS) feed.

One illustrative example of the system provided in embodiment 50 includes the following. A digital out of home (DOOH) media player (120e) broadcasts, e.g. via an HDMI cable connection, a predetermined series of digital commercial advertisements (100-104) to a retail display (120e) within a consumer retail environment. The predetermined series of digital commercial advertisements (100-104) are displayed on a predefined time schedule and maintained on the predefined time schedule by a time stamp (112e) transmitted to the DOOH media player (120e) via a Universal Serial Bus (USB) Global Position System (GPS) satellite receiver.

As an individual/consumer with a smartphone (180e) views the DOOH media player (120e), the displayed presentation advertisements (100-104) encourage the consumer to engage their smartphone (180e) with a nearby NFC tag. The consumer then “Taps” (130e) the nearby NFC tag with their smartphone (180e) and the smartphone browser executes a URL call (140e) to the platform (200e). The URL call (140e) is received by the platform (200e) which in turn routes the incoming URL call (140e) to interactive mobile coupons (160e-164e) that match in context with the particular DOOH media player advertisement that is on display at the time of the consumer's “Tap” or engagement (130e). Then one or more of the synchronized interactive mobile coupons (160e-164e) is/are naturally displayed on the smartphone 180e for the consumer to view, read, listen to, feel, etc (190e).

The platform's pre-determined URL routing schedule is kept accurate or in-sync with the predetermined series of digital commercial advertisements (100-104) by a time stamp (116e) via an NTS server feed. While not directly connected, it is considered an ideal configuration when the two time stamp sources are less than one second apart from perfect parallel synchronization. As such, all interactions take place in near-real-time and for the consumer, who remains unaware as to the timing, sequence and/or synchronization of all routing and content delivery, appear as a seamless, relatively real-time “tap to get content” experience.

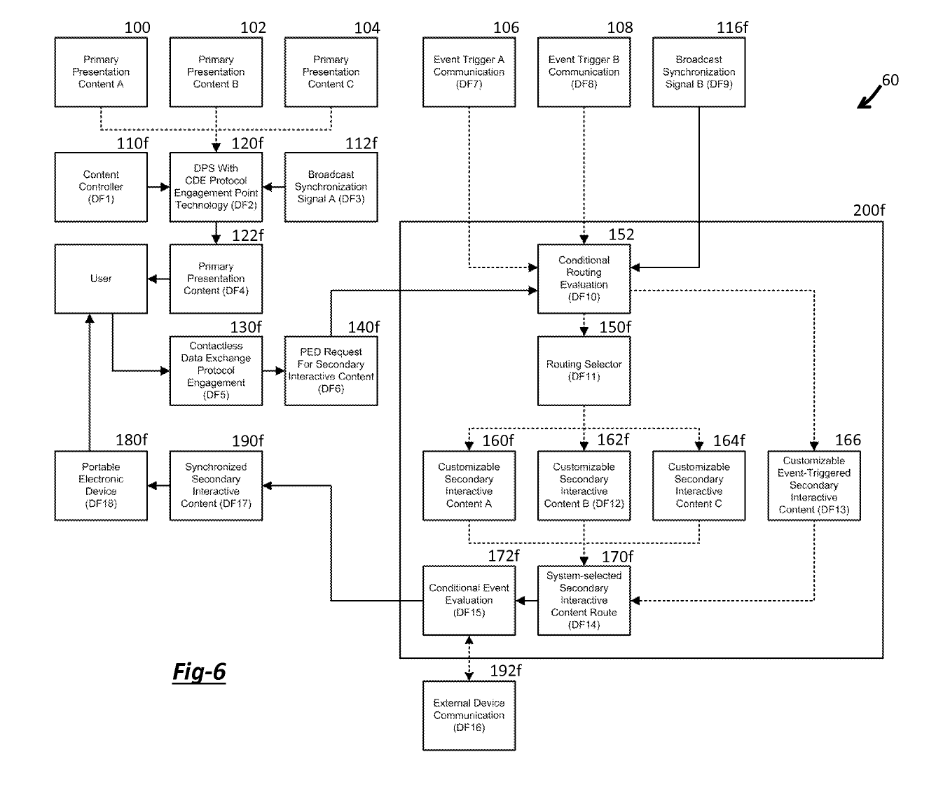

Turning now to FIG. 6, another embodiment is shown where broadcast synchronization emanates from one or more sources to two or more targets with one broadcast synchronization signal driving a DPS and another broadcast synchronization signal driving an interactive content platform. In particular, a selection of DPP 100-104 is made by a Content Controller 110f, e.g. DPP Content 102, and that selection is sent to a DPS with CDE Protocol Engagement Point Technology 120f, e.g. a media player (DF2). Also, a Broadcast Synchronization Signal A 112f is sent to and drives the DPS 120f and a Broadcast Synchronization Signal B 116f is sent to Interactive Content Platform 200f. The selected DPP Content 102 is presented to the User at 122f (DF4). Then, the User actively engages with the DPS's CDE Protocol Engagement Point Technology 120f via a Contactless Data Exchange Protocol Engagement 130f (DF5) and the User's PED 180f requests Secondary Interactive Content at 140f (DF6). However, the request for Secondary Interactive Content is now directed through a Conditional Routing Evaluation 152 before reaching the Routing Selector 150f.

Also routed through the Conditional Routing Evaluation is one or more Event Trigger Communications 106-108, as is the Broadcast Synchronization Signal B 116f. Then, and as a function of the PED request for Secondary Interactive Content 140f and the Broadcast Synchronization Signal B 116f, the Routing Selector 150f selects a CDSI Content 160f-164f to be provided to the System-selected Interactive Content Route 170f. In addition, Event-Triggered CDSI Content 166 is provided to the System-selected Interactive Content Route 170f.

Given the selected CDSI Content 160f-164f and the Event-Triggered CDSI Content 166, a Conditional Event Evaluation 172f routes Synchronized CDSI Content 190f to the User's PED 180f and/or provides communication to an External Device Communication 192f. In addition, it is appreciated that the system illustrated in FIG. 6 may also employ communication to external systems as determined by preset conditions within the system having been satisfied or when acting as a repeater or translator of communication received by external devices. It is also appreciated that similar to the system illustrated in FIG. 5, the system illustrated in FIG. 6 affords the DPS 120f and the Interactive Content Platform 200f to be directed by broadcast synchronization signals coming from different sources. For example and for illustrative purposes only, the Broadcast Synchronization Signal A 112f can be satellite-fed time signature and the Broadcast Synchronization Signal B 116f can be an NTS feed.

One illustrative example of the system provided in embodiment 60 includes the following. A digital out of home (DOOH) media player (120f) broadcasts, e.g. via an HDMI cable connection, a predetermined series of digital commercial advertisements (100-104) to a retail display within a consumer retail environment. The predetermined series of digital commercial advertisements (100-104) are displayed on a predefined time schedule and maintained on the predefined time schedule by a time stamp (112f) transmitted to the DOOH media player via a USB GPS satellite receiver that receives a time stamp or time signal from the GPS satellite system as known to those skilled in the art.

As an individual/consumer with a smartphone (180f) views the DOOH media player (120f), the displayed presentation advertisements (100-104) encourage the consumer to engage their smartphone (180f) with a nearby NFC tag. The consumer then “Taps” (130f) the nearby NFC tag with their smartphone (180f) and the smartphone browser executes a URL call (140f) to the platform (200f). The URL call (140f) is received by the platform (200f) which in turn routes the incoming URL call (140f) to one or more interactive mobile coupons (160f-164f) that match in context with the particular DOOH media player advertisement that is on display at the time of the consumer's “Tap” or engagement 130f.

However, in embodiment 60, the platform 200f is set to route to the pre-programmed mobile content (160f-164f) only if the number of “Followers” of a third-party's Twitter account reaches 1,000,000 (172f), which would be determined by the platform 200f via an incoming Event Trigger (106-108) in the form of an Application Program Interface (API) URL call. With this external Event evaluation (172f) in place, the DOOH media player's presentation might include a disclaimer, pronouncing that the mobile content which would normally be accessible without the 1,000,000 Followers requirement, is now only made accessible if the Twitter account reaches 1,000,000 Followers. It is appreciated that such a disclaimer could encourage the consumer to start to “Follow” the third-party Twitter account, i.e. such a disclaimer could encourage an individual/customer to become a follower of the third party's Twitter account in order to see the mobile content. Also, once the 1,000,000 Twitter Follower threshold requirement (172f) mentioned above has been met, the one or more of the synchronized interactive mobile coupons (160e-164e) is/are displayed on the smartphone 180e for the consumer to view, read, listen to, feel, etc (190e).

The platform's pre-determined URL routing schedule is kept accurate or in-sync with the predetermined series of digital commercial advertisements (100-104) by a time stamp (116f) via an NTS feed. While not directly connected, it is considered an ideal configuration when the two time stamp sources are less than one second apart from perfect parallel synchronization. As such, all interactions take place in near-real-time and for the consumer, who remains unaware as to the timing, sequence and/or synchronization of all routing and content delivery, appear as a seamless, relatively real-time “tap to get content” experience.

In addition to the above, the platform 200f sends a pre-programmed email to a pre-programmed email address (192f) for a different PED, account, etc., which in turn notifies a Spanish-speaking sales representative in the vicinity of the consumer, that a likely Spanish-speaking consumer has just engaged the NFC tag. The fact that the consumer is likely Spanish-speaking is determined by the platform 200f and is based on the smartphone's browser settings being set to Spanish, the Spanish setting acting as a trigger to send the communication to the sales representative. As such, the embodiment 60 and the platform 200f are capable of facilitating targeted communication based on time, location and conditional events.

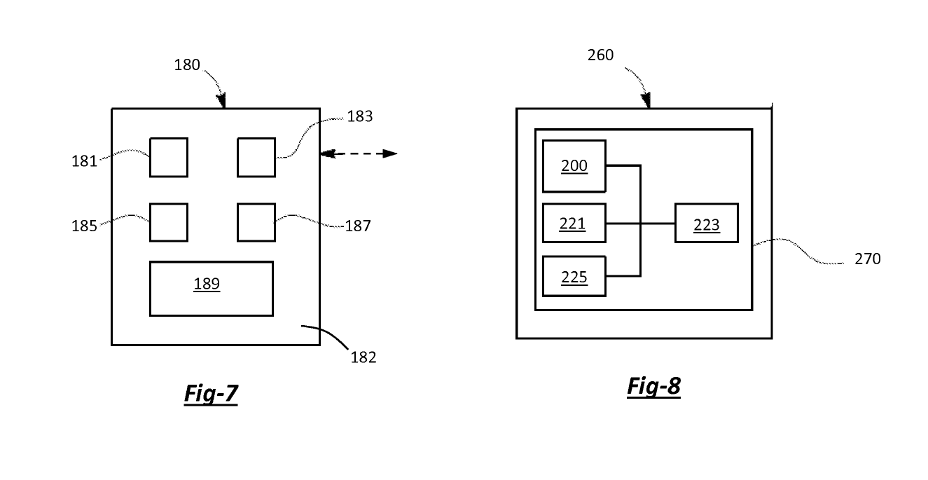

FIG. 7 provides a schematic illustration of a PED 180, for example a PED illustrated in FIGS. 1-6 as PED 180a-180f. The PED 180 can have one or more components as illustrated in the figure, for example a bar code scanner/reader 181, a QR code scanner or reader 183, an RFID tag reader or scanner 185, and/or an NFC tag scanner or reader 187. In addition, the PED 180 can have a software module 189 that communicates with the components 181-187 and directs communication with a communication network. The PED 180 also has a display screen 182 which can display DPP content and CDSI content as discussed above.

It should be appreciated that the term “screen” should not be limited to known two-dimensional lighted pixel-based panels. Stated differently, advanced screens, displays, etc., that are currently known or may be developed in the future and illustratively include Google Goggles, holograms, ocular implants, braille panels and the like are included within the scope of “screen.”

FIG. 8 illustrates a computer 260 which has a processing unit 270. The processing unit 270 can include some or the entire interactive content platform 200, for example the Interactive Content Platforms 200a-200f discussed in FIGS. 1-6 above. The computer 260, processing unit 270 and/or interactive content platform 200 can include memory 221, a software module 223 and a communication module 225 that are in electronic communication with each other. Also the interactive content platform 200 communicates with a communication network, e.g. the same communication network that the PED 180 communicates with. It is appreciated that the various components, systems, etc. of the digital electronic multimedia synchronizing and routing system disclosed herein and communicate with each via any network and communication system known to those skilled in the art, illustratively including the Internet, Local Area Networks (LAN), commercially provided wireless networks and the like.

The invention is not to be limited to the described embodiments herein. It is appreciated that one skilled in the art would make various changes, modifications, etc. and still fall within the scope of the invention. As such, it is the claims, and all equivalents thereof, which define the scope of the invention.

We claim:

1. A digital electronic multimedia synchronizing and routing system comprising:
a dynamic digital presentation system (DPS);
a content controller and a plurality of digital primary presentation (DPP) contents, said DPS and said content controller displaying each of said plurality of DPP contents on said DPS per a pre-defined time schedule;
an interactive content platform with a routing selector and a plurality of customizable digital secondary interactive (CDSI) contents, said interactive content platform with said routing selector in synchronization with said pre-defined time schedule of said display of each of said plurality of DPP contents, each of said plurality of CDSI contents having content related to a given DPP content;
a portable electronic device (PED) having an NFC tag reading system and a screen; and
an NFC tag programmed to direct said PED to said interactive content platform when said NFC tag reading system reads said NFC tag;
said interactive content platform with said routing selector operable to provide at least one of said plurality of CDSI contents to said PED to be displayed on said screen and be viewable by a user, said at least one of said plurality of CDSI contents provided and displayed on said PED screen being unique to a time when said NFC tag reading system reads said NFC tag.

2. The digital electronic multimedia synchronizing and routing system of claim 1, wherein said synchronization of said content controller with said interactive content platform with said routing selector is provided by a broadcast synchronization signal therebetween.

3. The digital electronic multimedia synchronizing and routing system of claim 2, wherein said DPS provides said broadcast synchronization signal to said interactive content platform.

4. The digital electronic multimedia synchronizing and routing system of claim 3, wherein said interactive content platform provides said broadcast synchronization signal to said content controller.

5. The digital electronic multimedia synchronizing and routing system of claim 1, wherein said NFC tag directs said PED to execute a URL call to said interactive content platform.

6. The digital electronic multimedia synchronizing and routing system of claim 5, further comprising an event-trigger communication to said interactive content platform and a customizable event-triggered CDSI content, said interactive content platform operable to increment or decrement an event-trigger variable as a function of said event-trigger communication.

7. The digital electronic multimedia synchronizing and routing system of claim 6, said interactive content platform has an event-trigger evaluation system operable to determine if said event-trigger variable has been met or exceeded a predetermined value.

8. The digital electronic multimedia synchronizing and routing system of claim 7, wherein said interactive content platform is operable to provide said event-triggered CDSI content to said PED when said event-triggered variable has met or exceeded said predetermined value.

9. The digital electronic multimedia synchronizing and routing system of claim 5, wherein said interactive content platform has a conditional event evaluation system operable to determine if a conditional event has been generated by said PED.

10. The digital electronic multimedia synchronizing and routing system of claim 9, wherein said conditional event evaluation system executes a conditional event task when said conditional event has been generated by said PED.

11. The digital electronic multimedia synchronizing and routing system of claim 10, wherein said conditional event task is transmission of a communication to a third party.

12. A digital electronic multimedia synchronizing and routing system comprising:
a dynamic digital presentation system (DPS);
a content controller and a plurality of digital primary presentation (DPP) contents, said DPS and said content controller displaying each of said plurality of DPP contents on said DPS per a pre-defined time schedule;
an interactive content platform with a routing selector and a plurality of customizable digital secondary interactive (CDSI) contents, said interactive content platform with said routing selector in synchronization with said pre-defined time schedule of said display of each of said plurality of DPP contents, each of said plurality of CDSI contents having content related to a given DPP content;
a portable electronic device (PED) having an contactless data-exchange reading system and a screen; and
a contactless data-exchange object programmed to direct said PED to said interactive content platform when said contactless data-exchange reading system reads said contactless data-exchange object;
said interactive content platform with said routing selector operable to provide at least one of said plurality of CDSI contents to said PED to be displayed on said screen and be viewable by a user, said at least one of said plurality of CDSI contents provided and displayed on said PED screen being unique to a time when said contactless data-exchange reading system reads said contactless data-exchange tag.

13. The digital electronic multimedia synchronizing and routing system of claim 12, wherein said synchronization of said content controller with said interactive content platform with said routing selector is provided by a broadcast synchronization signal therebetween.

14. The digital electronic multimedia synchronizing and routing system of claim 13, wherein said DPS provides said broadcast synchronization signal to said interactive content platform.

15. The digital electronic multimedia synchronizing and routing system of claim 12, wherein said interactive content platform provides said broadcast synchronization signal to said content controller.

16. The digital electronic multimedia synchronizing and routing system of claim 12, wherein said contactless data-exchange object directs said PED to execute a URL call to said interactive content platform.

17. The digital electronic multimedia synchronizing and routing system of claim 16, further comprising an event-trigger communication to said interactive content platform and a customizable event-triggered CDSI content, said interactive content platform operable to increment or decrement an event-trigger variable as a function of said event-trigger communication.

18. The digital electronic multimedia synchronizing and routing system of claim 17, said interactive content platform has an event-trigger evaluation system operable to determine if said event-trigger variable has been met or exceeded a predetermined value.

19. The digital electronic multimedia synchronizing and routing system of claim 18, wherein said interactive content platform is operable to provide said event-triggered CDSI content to said PED when said event-triggered variable has met or exceeded said predetermined value.

20. The digital electronic multimedia synchronizing and routing system of claim 16, wherein said interactive content platform has a conditional event evaluation system operable to determine if a conditional event has been generated by said PED, said conditional event evaluation system executing a conditional event task when said conditional event has been generated by said PED.
